(19) United States
(12) Patent Application Publication
(10) Pub. No.: US 2015/0124713 A1
(43) Pub. Date: May 7, 2015

(54) Methods Circuits Systems and Associated Computer Executable Code for Performing Beamforming Based Wireless Communication

(71) Applicants: Moshe Salhov, Herzeliya (IL); Roy Kinamon, Tel Aviv (IL)

(72) Inventors: Moshe Salhov, Herzeliya (IL); Roy Kinamon, Tel Aviv (IL)

(73) Assignee: GO NET SYSTEMS LTD., Tel Aviv (IL)

(21) Appl. No.: 14/238,737

(22) PCT Filed: Aug. 16, 2012
(86) PCT No.: PCT/IB2012/054184

§ 371 Date: Apr. 10, 2014

Related U.S. Application Data
(60) Provisional application No. 61/523,892, filed on Aug. 16, 2011.

(51) Int. Cl. H04B 7/08; H04B 7/06; H04B 17/21

(52) U.S. Cl. CPC H04B 7/08; H04B 17/21; H04B 7/06
USPC 370/329

(57) ABSTRACT

Disclosed are Bridging circuitries (BC100), and access points comprising BC100, which may be adapted to perform signal interfacing, signal conditioning, signal analysis and/or other signal processing to signals passing between RF Chains and Baseband Modem Circuits (BBMC), wherein interfacing, conditioning, analysis and/or processing may include: (1) Tx beam forming, (2) Rx Beam forming, (3) per beam Rx packet detection, (4) signal analysis and characterization and (4) MIMO spatial expansion. BC100 may include signal processing circuitry adapted to perform simultaneous multi-DOA estimation and packet detection upon multiple beams. BC100 may also be adapted to coordinate operation of the RF Chains and BBMC relative to one another. BC100 may also comprise memory for storing signal characteristics which may be utilized to improve its operation

### FIELD OF THE INVENTION

The present invention is generally related to the field of wireless communication. More specifically, the present invention is related to methods circuits systems and associated computer executable code for producing and operating beamforming wireless communication access points.

### BACKGROUND

Wireless data communication has rapidly evolved over the past decades smce its conception in 1970 by Norman Abramson, who developed the world's first computer communication network, ALOHAnet, using low-cost ham-like radios. With a bi-directional star topology, the ALOHAnet system connected seven computers deployed over four islands to communicate with the central computer on the Oahu Island without using phone lines.

In 1979, F. R. Gfeller and U. Bapst published a paper in the IEEE Proceedings reporting an experimental wireless local area network using diffused infrared communications. Shortly thereafter, in 1980, P. Ferrert reported on an experimental application of a single code spread spectrum radio for wireless terminal communications in the IEEE National Telecommunications Conference.

In 1984, a comparison between infrared and CDMA spread spectrum communications for wireless office information networks was published by Kaveh Pahlavan in IEEE Computer Networking Symposium which appeared later in the IEEE Communication Society Magazine. In May 1985, the efforts of Marcus led the FCC to announce experimental ISM bands for commercial application of spread spectrum technology. Later on, M. Kavehrad reported on an experimental wireless PBX system using code division multiple access. These efforts prompted significant industrial activities in the development of a new generation of wireless local area networks and it updated several old discussions in the portable and mobile radio industry.

The first generation of wireless data modems was developed in the early 1980s by amateur radio operators, who commonly referred to this as packet radio. They added a voice band data communication modem, with data rates below 9600-bit/s, to an existing short distance radio system, typically in the two meter amateur band. The second generation of wireless modems was developed immediately after the FCC announcement in the experimental bands for non-military use of the spread spectrum technology. These modems provided data rates on the order of hundreds of kbit/s. The third generation of wireless modem then aimed at compatibility with the existing LANs with data rates on the order of Mbit/s. Several companies developed the third generation products with data rates above 1 Mbit/s and a couple of products had already been announced by the time of the first IEEE Workshop on Wireless LANs.

The first of the IEEE Workshops on Wireless LAN was held in 1991. At that time early wireless LAN products had just appeared in the market and the IEEE 802.11 committee had just started its activities to develop a standard for wireless LANs. The focus of that first workshop was evaluation of the alternative technologies. By 1996, the technology was relatively mature, a variety of applications had been identified and addressed and technologies that enable these applications were well understood. Chip sets aimed at wireless LAN implementations and applications, a key enabling technology for rapid market growth, were emerging in the market. Wireless LANs were being used in hospitals, stock exchanges, and other in building and campus settings for nomadic access, point-to-point LAN bridges, ad-hoc networking, and even larger applications through Internetworking. The IEEE 802.11 standard and variants and alternatives, such as the wireless LAN interoperability forum and the European HiperLAN specification had made rapid progress, and the unlicensed PCS Unlicensed Personal Communications Services and the proposed SUPERNet, later on renamed as U-NII, bands also presented new opportunities.

IEEE 802.11 is a set of standards carrying out wireless local area network (WLAN) computer communication in the 2.4, 3.6 and 5 GHz frequency bands. They are created and maintained by the IEEE LAN/MAN Standards Committee (IEEE 802). The 802.11 family includes over-the-air modulation techniques that use the same basic protocol. The most popular are those defined by the 802.11b and 802.11g protocols, which are amendments to the original standard. 802.11-1997 was the first wireless networking standard, but 802.11b was the first widely accepted one, followed by 802.1Ig and 802.1In. Security was originally purposefully weak due to export requirements of some governments, and was later enhanced via the 802.11i amendment after governmental and legislative changes. 802.11n is a new multi-streaming modulation technique. Other standards in the family (c-f, h, j) are serVice amendments and extensions or corrections to the previous specifications.

As a means of extending range and improving data throughput of wireless communication systems, such as those defined under the 802 standards, beam-forming techniques and MIMO circuits have been integrated with or applied to the output of wireless transmitters. Beam-forming takes advantage of directionality of an antenna array. When transmitting, a beam-former controls the phase and relative amplitude of the signal at each antenna, in order to create a pattern of constructive and destructive interference in the wavefront. When receiving, information from different sensors/antennas is combined in such a way that the expected pattern of radiation is preferentially observed. MIMO refers to “multiple-input and multiple-output”—a technology which uses multiple antennas at both the transmitter and receiver to improve communication performance. MIMO is one of several forms of smart/adaptive antenna technologies, and may be sub-divided into three main categories, precoding, spatial multiplexing or SM, and diversity coding:

Precoding is multi-layer beamforming in its narrowest definition. In more general terms, it is considered to be all spatial processing that occurs at the transmitter. In (single-layer) beamforming, the same signal is emitted from each of the transmit antennas with appropriate phase (and sometimes gain) weighting such that the signal power is maximized at the receiver input. The benefits of beamforming are to increase the signal gain from constructive interference and to reduce the multipath fading effect. In the absence of scattering, beamforming results in a well-defined directional pattern, but in typical cellular conventional beams are not a good analogy. When the receiver has multiple antennas, the transmit beamforming cannot simultaneously maximize the signal level at all of the receive antennas, and precoding is used. Spatial multiplexing requires MIMO antenna configuration. In spatial multiplexing, a high rate signal is split into multiple lower rate streams and each stream is transmitted from a different transmit antenna in the same frequency channel. If these signals arrive at the receiver antenna array with sufficiently different spatial signatures, the receiver can separate these streams, creating parallel channels free. Spatial multiplexing is a very powerful technique for increasing channel capacity at higher signal-to-noise ratios (SNR). The maximum number of spatial streams is limited by the lesser in the number of antennas at the transmitter or receiver. Spatial multiplexing can be used with or without transmit channel knowledge.

Diversity Coding techniques are used when there is no channel knowledge at the transmitter. In diversity methods a single stream (unlike multiple streams in spatial multiplexing) is transmitted, but the signal is coded using techniques called space-time coding. The signal is emitted from each of the transmit antennas with full or near orthogonal coding. Diversity coding exploits the independent fading in the multiple antenna links to enhance signal diversity.

Spatial multiplexing can also be combined with precoding when the channel is known at the transmitter or combined with diversity coding when decoding reliability is in trade-off.

MIMO and beam-forming technologies have been applied to various wireless transmission modulation schemes/protocols by solution providers (i.e. WLAN integrators and WiFi access point manufacturers) by placing MIMO or beam-forming circuits/logic at the output of wireless data transmit and receive chains. MIMO and beam-forming technologies have only recently been incorporated into a wireless transmission standard, namely 802.11n. The use of beamforming, with or without MIMO, however presents various challenges relating to: (1) beam direction selection and weighting for multipath packet reception, (2) beam direction selection and weighting selection for multipath packet transmission, (3) multipath/multibeam time-of-arrival diversity compensation, (4) correlation and boosting of received noise, and (5) various other complex and uncontrollable S/R degrading phenomenon which may occur when attempting to receive and decode a data bearing signal or packet which has traveled an unknown distance through an unshielded noisy free-space shared medium from a source whose location and transmission configuration are not previously accurately known.

There is therefore a need in the field of wireless communication for improved methods, circuits, device and system for facilitating wireless data communication.

### SUMMARY OF INVENTION

The present invention includes methods, circuits, apparatus, devices, systems and computer executable code for processing wireless signals. According to some embodiments of the present invention, there may be provided a wireless communication system including Radio Frequency Circuitry having multiple Receive (Rx) chains and Transmit (Tx) chains (hereinafter referred to as Rx Chains and Tx Chains and collectively as RF chains), one or more baseband modem circuits (BBMC) (such as those produced by Atheros, TI, Marvel, Qualcomm, Intel, etc.), and Bridging Circuitry (“BC100”) for facilitating transfer of payload bearing signals between the RF chains and the BBMC. BC100 may be adapted to perform signal interfacing, signal conditioning, signal analysis and/or other signal preprocessing to signals passing between the RF Chains and the BBMC, wherein interfacing, conditioning, analysis and/or processing may include: (1) Tx beam forming, (2) Rx Beam forming, (3) simultaneous packet detection and multi-DOA estimation (“DOA”=Direction of Arrival), (4) signal analysis and characterization, (5) MIMO whitening and spatial expansion and (6) any other signal processing or treatment known today or to be devised in the future. BC100 may include signal processing circuitry adapted to perform simultaneous multi-DOA estimation and packet detection upon multiple beams. BC100 may also be adapted to coordinate operation of the RF Chains and BBMC relative to one another. According to further embodiments, BC100 may be further adapted to calibrate the RF chains.

According to some embodiments, BC100 may comprise multiple parallel signal paths, wherein portions of the described signal processing performed by BC100 (e.g. signal characterization, packet detection and DOA estimation) may be performed on a signal detection path parallel to the data path (data path=the signal path which leads between the RF Chains and the BBMC). Within embodiments including parallel signal paths, processing and detection may be performed on signals on a parallel signal path in order to determine signal processing parameters which may be used to process the parallel signals within the data path.

According to some embodiments, BC100 may comprise one or more signal inputs for receiving signals from Rx chains. According to some embodiments, BC100 may comprise Signal Characterizing and Packet Detection Circuitry (“SCPDC”), comprising one or more Packet Detectors and signal sensing and characterizing circuitry. According to some embodiments, SCPDC may be adapted to perform simultaneous/joint packet detection and multi-DOA estimation.

According to further embodiments, BC100 may also comprise a Dynamic/Controllable Rx beamforming unit adapted to beamform the signals received at associated Rx chains based on their estimated DOAs. According to some embodiments, a Dynamic/Controllable Rx beamforming unit may receive parameters for beamforming of received signals from a SCPDC or detection logic functionally associated with a SCPDC.

According to yet further embodiments, BC100 may further comprise a Rx MIMO whitener unit for performing signal processing of the multi beam resulting from the Rx beamforming. According to some embodiments, a Rx MIMO whitener unit may receive from an associated controller parameters relating to whitening of specific Rx signals, wherein the associated controller may determine these parameters at least partially based on signal characteristics and/or parameters derived from signal characteristics of the specific Rx signals. According to further embodiments, a packet detector may notify the controller of the received signal and its characteristics. According to some embodiments, whitening may comprise decorrelating noise across multiple inputs. According to further embodiments, whitening may comprise decorrelating noise across multiple inputs while relaying one antenna signal intact, i.e. as it was when received by the whitening unit;

According to some embodiments, BC100 may comprise a Tx MIMO expansion unit for performing MIMO expansion of Tx signals originating from the BBMC. According to some embodiments, a Tx MIMO expansion unit may receive from an associated controller parameters relating to spatial expansion of specific BBMC signals, wherein the associated controller may determine these parameters at least partially based on signal characteristics and/or parameters derived from signal characteristics associated with the given wireless client the Tx signals are intended for. These signal characteristics or derived parameters may be derived from previous communication with the given client. According to further embodiments, a BBMC may notify the controller of the intended transmission.

According to further embodiments, BC100 may further comprise a Tx Beam-forming unit for forming Tx signals originating from the BBMC into beams. According to some embodiments, a Tx Beam-forming unit may receive from an associated controller parameters relating to the beams formed, wherein the associated controller may determine these parameters at least partially based on signal characteristics (e.g. DOA) and/or parameters derived from signal characteristics (e.g. weights), associated with the given wireless client the signals are intended for. These signal characteristics or derived parameters may be derived from previous communication with the given client. According to further embodiments, a BBMC may notify the controller of the intended transmission;

According to some embodiments, BC100 may comprise one or more Controllers, hereinafter collectively referred to as a controller. It should be understood that functions described herein as being performed by the controller may be performed by separate processing logic contained within BC100 (e.g. detection logic directly associated with packet detection circuitry). According to some embodiments, the controller(s) may comprise: (1) control logic for coordinating the signal processing performed by BC100 upon signals exchanged between the BBMC and the RF chains; (2) signal processing logic for determining processing parameters to be used when processing a given signal; (3) control logic for controlling the RF chains and controlling and synchronizing between the BBMC and the RF chains.

According to some embodiments of the present invention, BC100 may perform beamforming of signals received at associated RF chains. According to further embodiments, Beamforming may be based on one or more estimated DOAs of the received signals and/or based on a determination of the best DOA's of the received signals.

According to some embodiments, BC100 may be adapted to detect data packets within signals received at associated RF chains, i.e. Packet detection. According to some embodiments, BC100 may perform beam specific packet detection and may further determine and include in the results of the packet detection signal characteristics and/or processing parameters associated with detected packets.

According to further embodiments, BC100 may analyze/preprocess signals received at associated RF chains and perform signal characterization of the signals received. According to some embodiments, signal characterization may be performed in conjunction with packet detection, as explained in further detail below. Furthermore, signal characteristics determined in relation to a given signal may subsequently be used to process the signal.

According to yet further embodiments, BC100 may further perform MIMO expansion and whitening of signals exchanged between BBMC and RF chains. According to some embodiments, MIMO expansion and whitening of signals may be performed based on signal characteristics previously determined for a given wireless client/signal. According to some embodiments, whitening may comprise decorrelating noise across multiple inputs. According to further embodiments, whitening may comprise decorrelating noise across multiple inputs, while keeping a single whitener unit input from the multiple signals unchanged. Accordingly, the resulting multi beamformed signal may be decorrelated whilst one of the signals may not have been affected by the decorrelation process.

According to some embodiments, BC100 may be adapted to perform Multi-stream signal processing. According to some embodiments, the functions described herein may be performed on both multi-stream and single-stream signals, both during Rx and Tx, as further described below.

According to further embodiments, BC100 may coordinate operation of RF chains and BBMC. According to some embodiments, BC100 may coordinate Rx and Tx operation of the RF chains and BBMC. BC100 may switch between Rx active, Rx passive and Tx active modes. According to further embodiments, BC100 may provide control signals for data path beamforming, which may include both beamforming parameters and triggers for both multi-stream and single-stream transmissions/packets. Determination of mode may be based on status indications and transmission indications received from the BBMC and/or on packet detection. For example, BC100 may switch components to Rx active when a data packet is detected within a received signal. BC100 may switch components to Tx active when receiving a transmission indication from the BBMC. BC100 may switch to Rx passive when receiving a modem status active from the BBMC.

According to some embodiments of the present invention, the described packet detection and signal characterization of received signals may be performed in parallel to and/or within the data path. The packet detection and signal characterization may be performed on a signal path parallel to the data path—a “detection path”. According to further embodiments of the present invention, a SCPDC connected in parallel to the data path may further comprise fixed beamforming circuitry (hereinafter referred to as: “fixed beamforming unit” or “FBFU”) (e.g. a multi-directional simultaneous beamforming component) and may perform simultaneous packet detection and DOA estimation upon a given received signal. Accordingly, the SCPDC may forward to the Dynamic/Controllable Rx Beamforming Unit beamforming parameters (e.g. weights) to be applied to a given received signal within the data path [as shown in FIGS. 1B & 2A]. According to yet further embodiments, a SCPDC may further send a Rx active indication signal to the Rx components when a packet is detected within a received signal, such that only signals containing packets are forwarded to the BBMC and these are processed, prior to being forwarded to the BBMC, based on the signal characteristics determined by the SCPDC.

According to further embodiments of the present invention, there may be provided Bridging Circuitry as described in this disclosure (BC100), which may be adapted to be connected to existing RF chains and/or baseband modem circuits (BBMC's) and further adapted to interface between the existing RF chains and BBMC's and perform the functions described herein in relation to existing RF Chains and BBMC's.

According to some embodiments, there may be provided a wireless communication system comprising: a radio block comprising two or more radio frequency chains for receiving and transmitting wireless signals including wireless data packets, a modem block comprising one or more baseband modem circuits; and bridging circuitry which may be situated on a signal path between said radio block and said modem block and may be adapted to perform digital preprocessing of signals received by said radio frequency chains and to forward the preprocessed signals to at least one of said one or more modem circuits, said bridging circuitry may comprise:
(1) wireless packet detection and characterization circuitry which may be adapted to detect arrival of a given wireless packet and estimate one or more directions from which the given wireless packet is arriving;
(2) direction selection logic which may be adapted to select two or more wireless packet arrival directions for reception; and
(3) a dynamic Rx beamforming unit which may be adapted to either generate or to steer an Rx beam in each of the selected wireless packet arrival directions. Said direction selection logic may be adapted to select two or more directions for reception based on detected packet parameters determined by said packet detection and characterization circuitry. Packet parameters used to select the two or more directions for reception may be selected from the group consisting of: (1) post-beamforming energy within cyclic prefix of detected packet preamble; (2) A ratio of post-beamforming energy within cyclic prefix of detected packet preamble over the energy outside of the cyclic prefix of detected packet preamble; and (3) a ratio of post beamforming energy within cyclic prefix of detected packet preamble over the energy outside of the cyclic prefix of detected packet preamble combined with the estimated noise energy. Furthermore, a maximum allowable beam overlap threshold may be factored as part of selecting two or more directions for reception and dynamic beamforming.

According to further embodiments, wireless packet detection and characterization circuitry may comprise a set of match filters, wherein substantially each match filter may be configured for a specific direction of arrival. Each match filter may be configured for a specific direction of arrival and a specific client transmission antenna configuration.

According to further embodiments, wireless packet detection and characterization circuitry may comprise time of arrival (TOA) measurement or estimation functionality for determining a difference in time of arrival for the given packet from different directions. Accordingly, output at beam ports of the beamforming unit may be dynamically adjusted or delayed for the given packet based on the TOA estimates for each of the selected packet reception directions.

According to yet further embodiments, bridging circuitry may comprise a Whitener unit for whitening beamformed signals. Whitening may comprise decorrelating noise across multiple inputs while relaying one antenna signal without decorrelation, such that said whitener unit outputs two or more signals comprising decorrelated noise and one signal unchanged from its form as received by an RF Chain. Furthermore, the whitener unit may be adapted to perform whitening of given received signals based on signal parameters determined by said packet detection and characterization circuitry in relation to the given received signals.

According to yet further embodiments, there may also be provided a calibration network. The Bridging circuitry may: (1) use said calibration network to determine phase differences between said radio frequency chains; and (2) compensate for the determined phase differences.

According to some embodiments, bridging circuitry may be adapted to perform digital preprocessing of signals received from said one or more modem circuits and to forward the preprocessed signals to at least one of said radio frequency chains for transmission. Bridging circuitry may comprise a dynamic Tx beamforming unit adapted to perform beamforming upon signals received from said modem circuits and a controller which may be adapted to cause said Tx beamforming unit to perform beamforming, of two or more beams in two or more selected directions, for transmitting a signal generated by said modem circuits and intended for the given client device, wherein direction selection for Tx beamforming may be at least partially based on parameters determined by said packet detection and characterization circuitry for the given wireless packet received from the given client device. Packet parameters used to select two or more directions for Tx beamforming may be selected from the group consisting of: (1) post-beamforming energy within cyclic prefix of detected packet preamble; (2) A ratio of post-beamforming energy within cyclic prefix of detected packet preamble over the energy outside of the cyclic prefix of detected packet preamble; and (3) a ratio of post beamforming energy within cyclic prefix of detected packet preamble over the energy outside of the cyclic prefix of detected packet preamble combined with the estimated noise energy. Furthermore, a maximum allowable beam overlap threshold may be factored as part of selecting two or more directions for Tx beamforming. According to further embodiments, Tx beamforming may include selection of an energy level per selected Tx direction. Furthermore, Tx beamforming may include selection of a delay to apply to each beam port of said Tx beamforming unit.

According to yet further embodiments, said bridging circuitry may be further adapted to perform spatial expansion upon the signal generated by said modem circuits based on the parameters determined by said packet detection and characterization circuitry in relation to the one or more signals received from the wireless client.

Digital Communications by John G Proakis Published by McGraw-Hill Science/Engineering/Math; 5th edition (Nov. 6, 2007), is hereby incorporated by reference in its entirety.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1B: are block diagrams of exemplary Access Points including BC100, in accordance with some embodiments of the present invention, wherein:

FIG. 1A—exemplifies some embodiments in which packet detection and signal characterization is performed on the data path; and

FIG. 1B—exemplifies some embodiments in which packet detection and signal characterization is performed on a detection signal data path parallel to the data path;

FIGS. 2A-2D: are block diagrams of exemplary BC100's, in accordance with some embodiments of the present invention, wherein:

FIG. 2A—exemplifies some embodiments in which packet detection and signal characterization is performed on a detection signal data path parallel to the data path and BC100 comprises a Rx Whitening Unit;

FIG. 2B—exemplifies some embodiments in which packet detection and signal characterization is performed on the data path and BC100 comprises a Rx Whitening Unit;

FIG. 2C—exemplifies some embodiments in which packet detection and signal characterization is performed on a detection signal data path parallel to the data path and signals are forwarded to BBMC by a switch/multiplexer without whitening; and

FIG. 2D—exemplifies some embodiments in which packet detection and signal characterization is performed on the data path and signals are forwarded to BBMC by a switch/multiplexer without whitening;

FIGS. 3A-3B: are flowcharts of exemplary steps of operation of BC100 in relation to a signal received at an AP Rx chain, all in accordance with some embodiments of the present invention, wherein:

FIG. 3A—exemplifies some embodiments in which packet detection and signal characterization is performed on a detection signal data path parallel to the data path and BC100 comprises a Rx Whitening Unit; and

FIG. 3B—exemplifies some embodiments in which packet detection and signal characterization is performed on the data path and signals are forwarded to BBMC by a switch/multiplexer without whitening;

FIGS. 4A-4B: are flowcharts of exemplary steps of operation of BC100 in relation to a signal transmitted from an AP Tx chain, all in accordance with some embodiments of the present invention, wherein:

FIG. 4A—exemplifies some embodiments in which BC100 performs MIMO expansion of TX signals; and

FIG. 4B—exemplifies some embodiments in which BC100 does not perform MIMO expansion of TX signals;

and

FIGS. 5A-5B: are block diagrams of exemplary access points including BC100 and a calibration network, in accordance with some embodiments of the present invention, wherein:

FIG. 5A—demonstrates an exemplary process of TX array calibration, in accordance with some embodiments of the present invention; and

FIG. 5B—demonstrates an exemplary process of RX array calibration, in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

It should be understood that the accompanying drawings are presented solely to elucidate the following detailed description, are therefore, exemplary in nature and do not include all the possible permutations of the present invention.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, general purpose or dedicated processor, controller, control logic, application specific integrated circuit (“ASIC”), field programmable gate array, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, DVDs, magnetic-optical disks, read-only memories (ROMs), random access memories (RAMs) electrically programmable/erasable read-only memories (EPROMs, EEPROMs, NROMs, FLASH, SONOS, etc.), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

It should be understood that some embodiments of the present invention may be used in a variety of applications. Although embodiments of the invention are not limited in this respect, one or more of the methods, devices and/or systems disclosed herein may be used in many applications, e.g., civil applications, military applications or any other suitable application. In some demonstrative embodiments the methods, devices and/or systems disclosed herein may be used in the field of computer networking, wireless computer networking, Personal Computers (PC), for example, as part of any suitable desktop PC, notebook PC, monitor, and/or PC accessories. In some demonstrative embodiments the methods, devices and/or systems disclosed herein may be used in the field of security and/or surveillance, for example, as part of any suitable security camera, and/or surveillance equipment. In some demonstrative embodiments the methods, devices and/or systems disclosed herein may be used in the fields of military, defense, digital signage, commercial displays, retail accessories, and/or any other suitable field or application.

The present disclosure is described in relation to OFDM wireless transmissions for convenience. It should be understood, however, that the principles of the invention as described herein are equally applicable to other forms of wireless transmissions (e.g. CCK, DSSS, LTE, WiFi, Wimax etc.) and should be considered to encompass methods and systems implementing other communication standards, with the necessary modifications.

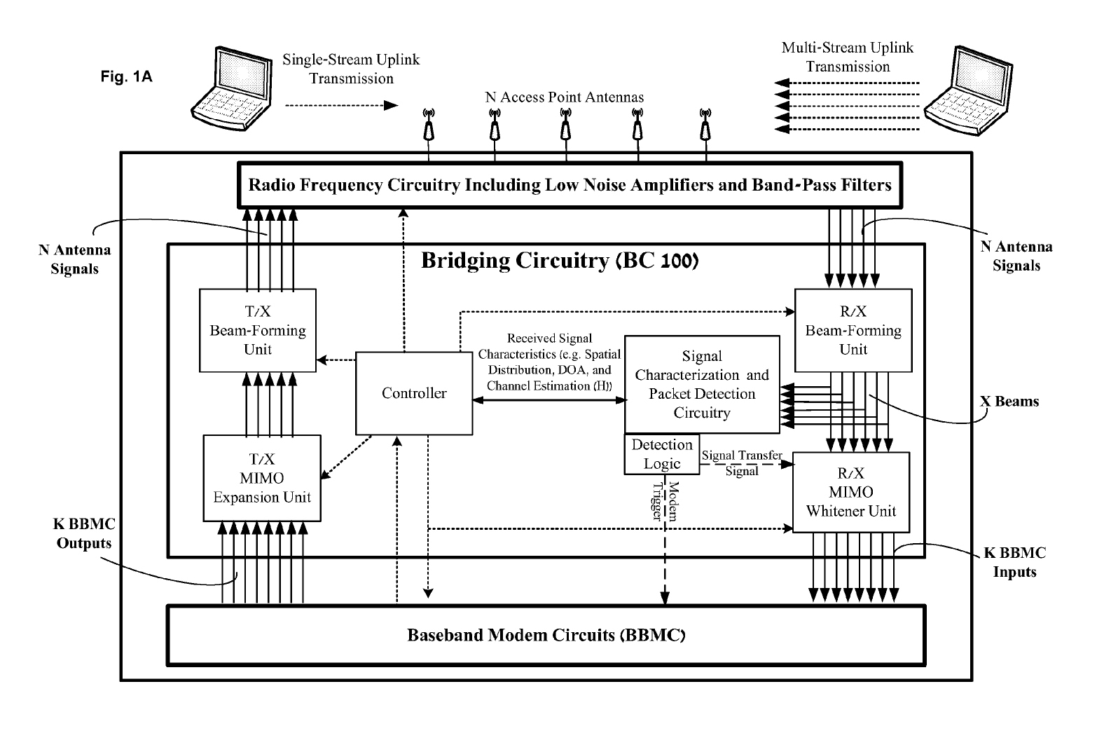

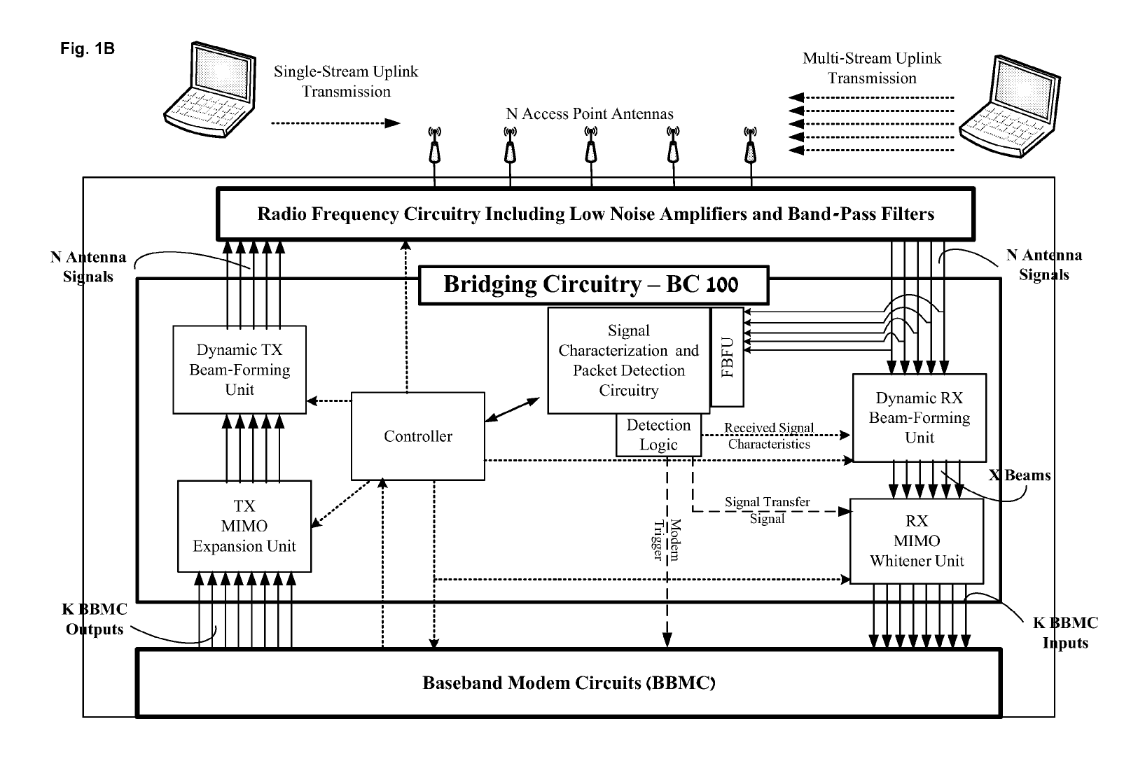

The present invention includes methods, circuits, apparatus, devices, systems and computer executable code for processing wireless signals. According to some embodiments of the present invention, there may be provided a wireless communication system [an example of which is shown in FIG. 1] including Radio Frequency Circuitry having multiple Receive (RX) chains and Transmit (TX) chains (hereinafter referred to as Rx Chains and Tx Chains and collectively as RF chains), one or more baseband modem circuits (BBMC) (such as those produced by Atheros, TI, Marvel, Qualcomm, Intel, etc.), and Bridging Circuitry (“BC100”) for facilitating transfer of payload data bearing signals between the RF chains and the BBMC. BC100 may be adapted to perform signal interfacing, signal conditioning, signal analysis and/or other signal processing to signals passing between the RF Chains and the BBMC, wherein interfacing, conditioning, analysis and/or processing may include: (1) TX beam forming, (2) RX Beam forming, (3) per beam RX packet detection, (4) signal analysis and characterization, (5) Rx signal whitening, (6) Tx MIMO spatial expansion, and (7) any other signal processing or treatment known today or to be devised in the future. BC100 may include signal processing circuitry adapted to perform simultaneous multi-DOA estimation and packet detection upon multiple beams. BC100 may also be adapted to coordinate operation of the RF Chains and BBMC relative to one another. According to further embodiments, signal processing performed by BC100 may be performed in the digital domain, after down-conversion from RF to base-band frequency, filtering, and/or sampling by analog to digital device. Accordingly, signals may be converted, by an appropriate A/D or D/A device, from analog to digital prior to or during entrance into BC100, from the RF chains (in the Rx) and/or the BBMC (in the Tx) and may further be converted from digital to analog prior to or as they are forwarded from BC100 to RF chains (in the Tx) and/or to the BBMC (in the Rx). According to further embodiments, BC100 may be further adapted to calibrate the Rx and Tx chains, which calibration may include compensating for relative phase differences between RF Chains, both in Rx and in Tx. According to some embodiments there may be provided a calibration network to facilitate calibration of the RF Chains.

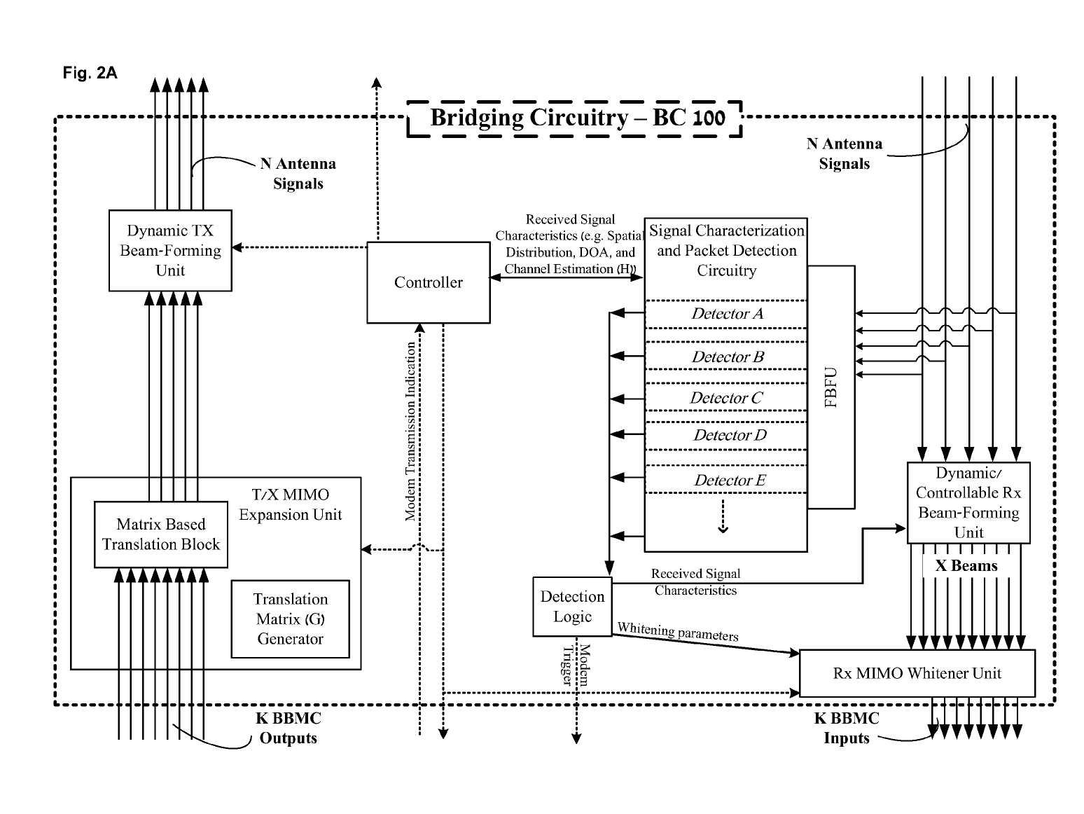

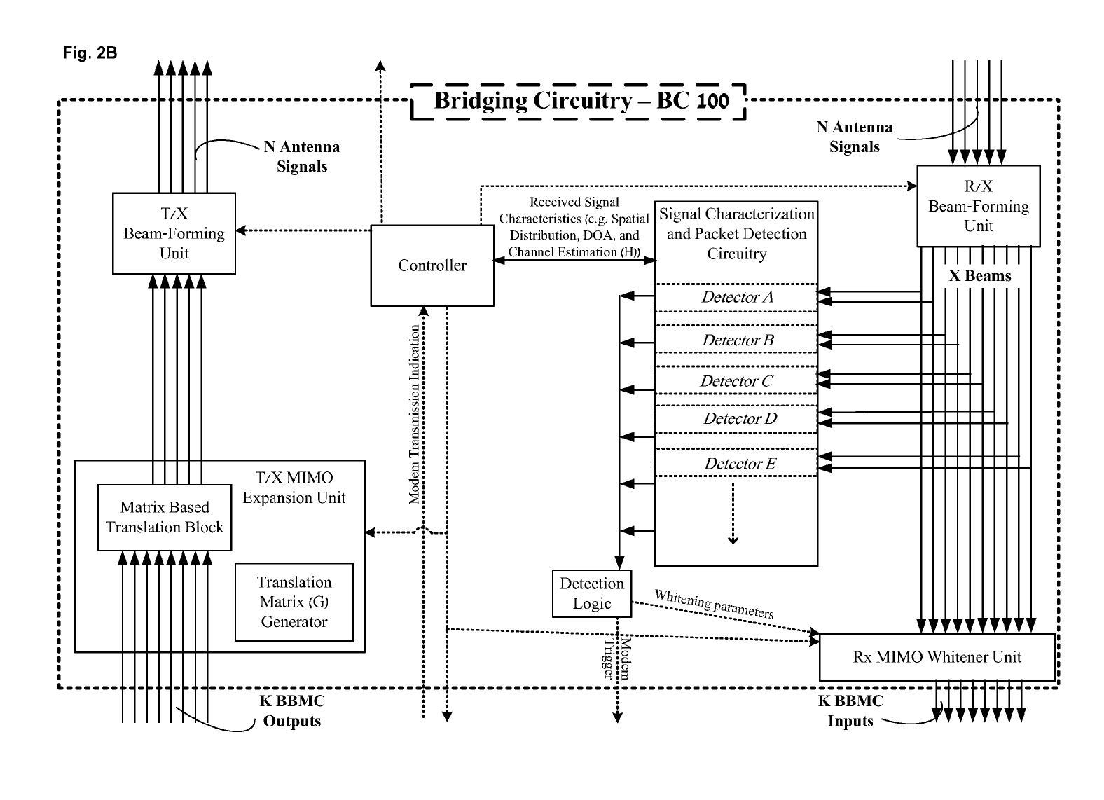

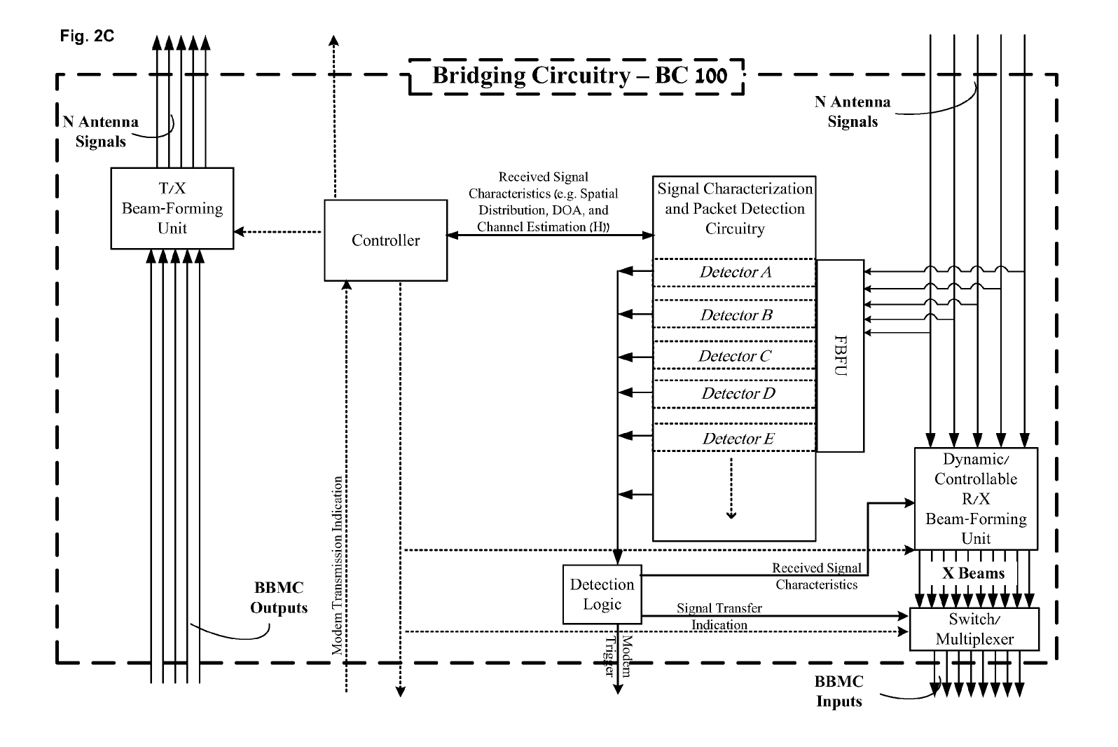

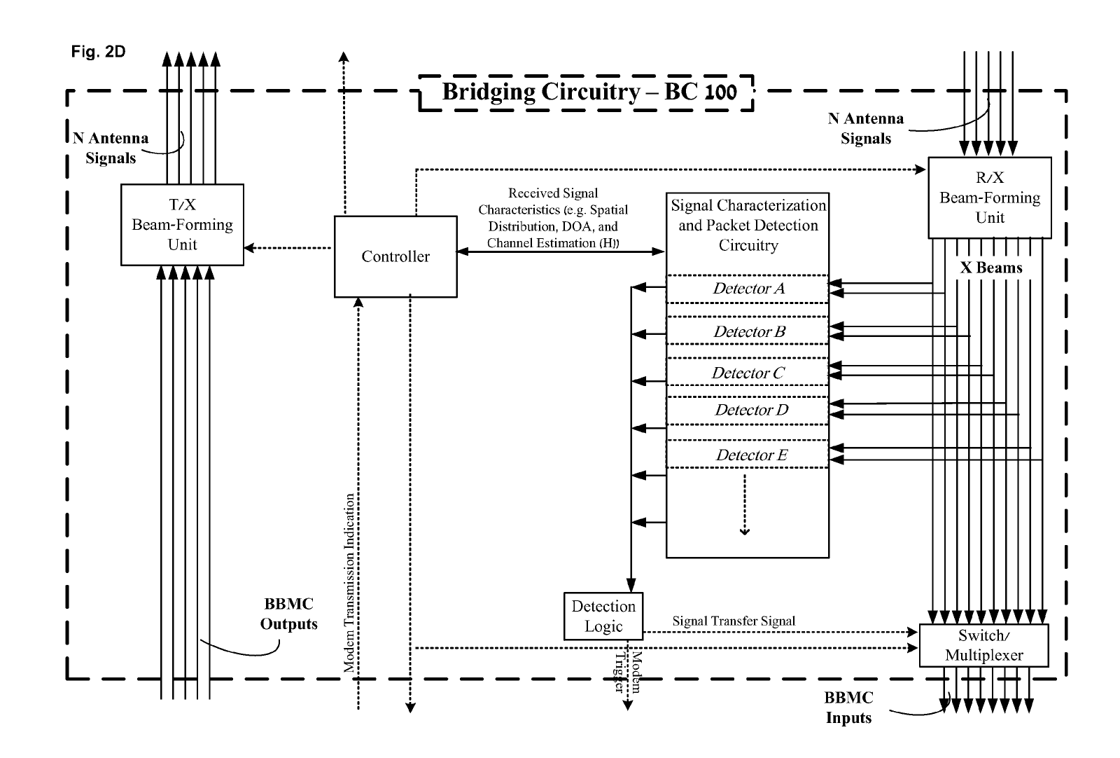

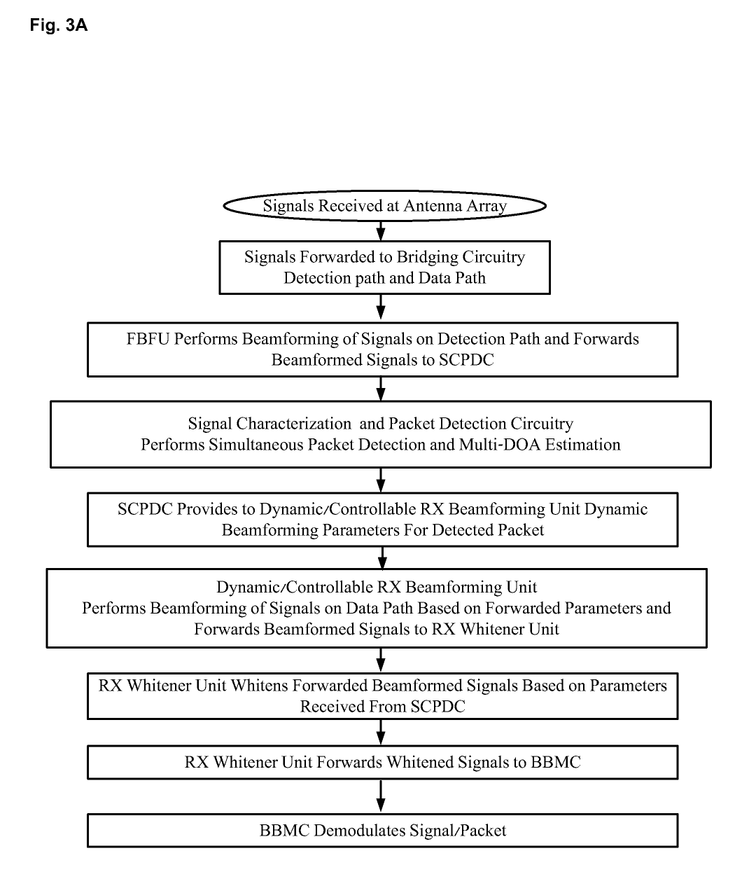

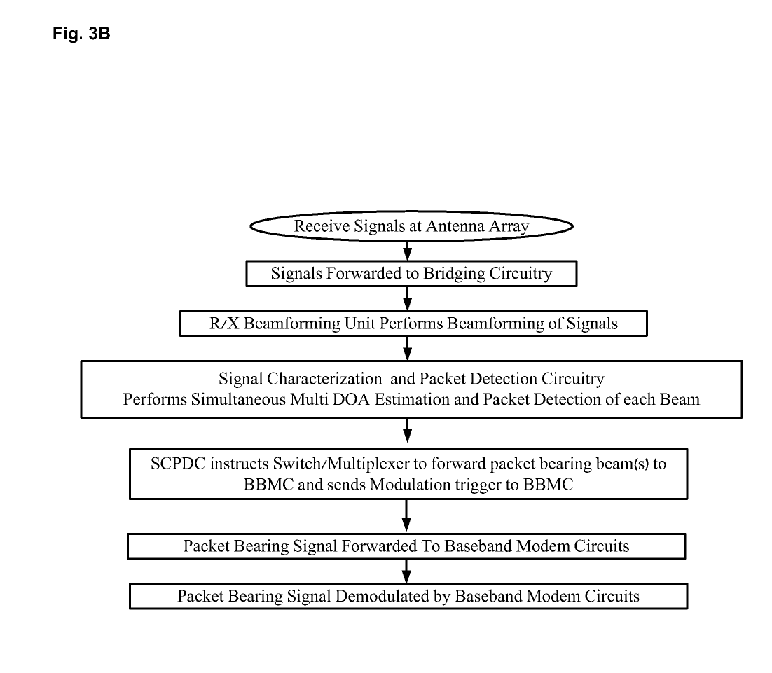

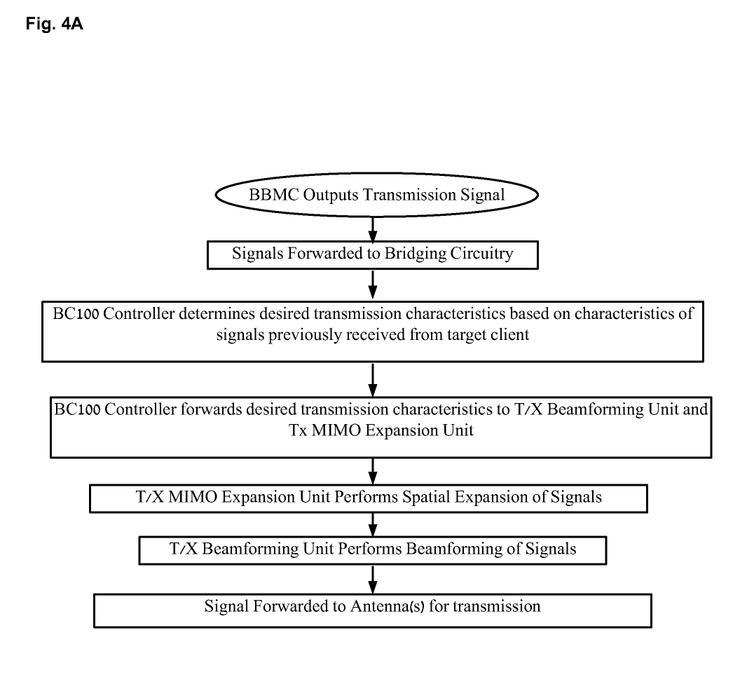

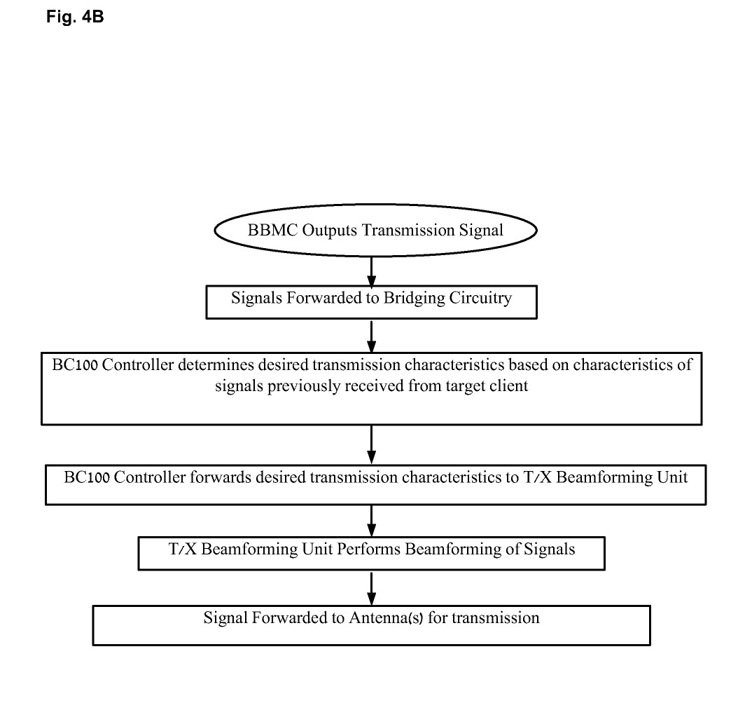

According to further embodiments of the present invention, there may be provided Bridging Circuitry as described in this disclosure (BC100) [an example of which is shown in FIGS. 2A & 2B], which may be adapted to be connected to existing RF chains and/or baseband modem circuits (BBMC's) and further adapted to interface between the existing RF chains and BBMC's and perform the functions described herein in relation to existing RF Chains and BBMC's.

According to some embodiments of the present invention, a wireless access point (AP) [an example of which is shown in FIGS. 1A & 1B] may comprise RF chains comprising a set of (N) antenna elements, wherein each element may be adapted to receive a version of a radio frequency transmission composed of data bearing signals including one or more transmitted spatial streams. The AP may also comprise BBMC comprising one or more multi-stream wireless modem circuits and/or one or more single-stream wireless modem circuits, which may include a set of K received signal input nodes and may be adapted to demodulate a received transmission including one or more spatial streams. An AP according to some embodiments of the present invention may further comprise or be functionally associated with BC100 to interface between the BBMC and the RF chains. According to further embodiments, BC100 may comprise control logic circuitry adapted to coordinate demodulation of a received transmission by either or both types of modem circuits. According to some embodiments, the control logic may direct a received transmission to both modems and detect which has demodulated the transmission first and/or best.

According to some embodiments, an AP may be adapted to operate in at least two modes: (1) a first mode where the AP's data signal modulation scheme does not include multiple spatial streams (e.g. as defined in the IEEE 802.11a, b, g standard for example), and (2) a second mode where the AP's data signal modulation scheme does include multiple spatial streams (e.g. as defined in the IEEE 802.11n standard for example). Either or both modes of operation may include signal modulation schemes such as DSSS, CCK and OFDM modulation. The BC100 may include a controller adapted to determine whether a given transmission of the AP or received by the AP would benefit from signal translation processing including: (1) beam-forming, (2) Signal characterization of signals received at the RF chain and channel estimation based signal weighting, (3) Packet detection, (4) Multi-Stream signal processing, (5) MRC/TxMRC, (6) signal whitening and/or (7) any other related signal processing known today or to be devised in the future and may apply any one of those or other known translation techniques. In the absence of beam-forming signaling in a transmission signal(s), the BC100 may include a Dynamic/Controllable TX beamforming unit adapted to generate and/or introduce beam-forming signaling into the transmission, which beam-forming may apply to both single-stream and MIMO type signals.

A BC100 may further include Signal Characterizing and Packet Detection Circuitry (“SCPDC”), comprising one or more Packet Detectors and signal sensing and characterizing circuitry adapted to analyze received transmissions and determine: (1) spatial distribution information relating to signals of the given received transmission; (2) DOA information relating to signals of the given received transmission; and (3) Channel Estimation (H) relating to signals of the given received transmission. The characterization information relating to a received transmission may also include one or more DOA's of received transmission signals. According to further embodiments, characterization information may further include one or more DOA's of received transmission signals determined to have: (a) a relatively high and/or highest Signal to Noise Ratio (SNR); and/or (b). a relatively high and/or highest Signal to Interference plus Noise Ratio (SINR), wherein the interference may be estimated prior to and/or during the packet arrival. According to some embodiments, signal characterization and packet detection may be performed on a per RF chain (per antenna) basis, i.e. signals received by each of one or more of the RF chains may be analyzed separately, such that packet detection and signal characterization may determine the above listed parameters for each individual RF chain. BC100 may further include control logic for deriving signal processing parameters from the detected signal characteristics.

According to some embodiments, SCPDC may be adapted to perform simultaneous/joint packet detection and DOA estimation based on the ability to identify both the existence and direction of arrival of a required signal featuring known characteristics, before it is forwarded to BBMC. Optionally, after identifying the existence and the direction of arrival of a required signal, the directions of arrival may be entered into a Dynamic/Controllable Rx beamforming Unit to obtain the signal coming from the required directions of arrival. The calculated signal may then be forwarded to BBMC.

According to some embodiments of the present invention, the described packet detection and signal characterization of received signals may be performed in parallel to [as shown in FIGS. 1B, 2A & 2C] and/or within the data path [as shown in FIGS. 1A, 2B & 2D]. The packet detection and signal characterization may be performed on a signal path parallel to the data path (data path=the signal path which leads between the Rx and Tx chains and the BBMC). According to further embodiments of the present invention, a SCPDC connected in parallel to the data path may further comprise a fixed beamforming unit (FBFU) (e.g. a multi-directional parallel beamforming component) and may perform simultaneous packet detection and DOA's estimation upon a given received signal. According to further embodiments, the FBFU may perform calculations in short word length, (i.e. low resolution or low dynamic range) in order to reduce hardware requirements. The short word length may be selected in such a way that it is enough for checking whether it is likely that at least one required signal is received by the antenna array, i.e. sufficient for packet detection. Accordingly, the SCPDC may forward to the Dynamic/Controllable Rx Beamforming Unit DOA's of a packet bearing signal and/or beamforming parameters (e.g. weights) to be applied to a given received signal within the data path [as shown in FIG. 1B]. The Dynamic/Controllable Beamforming Unit may then isolate the signal from the specified directions and/or according to the forwarded beamforming parameters. The isolation performed by the Beamforming Unit, within the data path, may use an improved dynamic range. This step may be optional because the signal can be forwarded to BBMC without an additional calculation featuring improved dynamic range. Hereinafter, the terms improved dynamic range and improved calculation precision have the same meaning. According to yet further embodiments, a SCPDC may further send a Rx active signal to the Rx components when a packet is detected within a received signal, such that only signals containing packets are forwarded to the BBMC and these are processed, prior to being forwarded to the BBMC, based on the signal characteristics determined by the SCPDC.

According to some embodiments of the present invention, SCPDC may comprise one or more packet detectors adapted to detect the presence of data packets within a received signal and further adapted to send a Rx Active signal to the BC100 controller in the event that a packet is detected within a received signal. The SCPDC may further forward to the controller detected signal characteristics associated with the packet bearing signal. The controller, when receiving an Rx active signal may send a demodulation trigger to the BBMC and further instruct a switch/multiplexer and/or a Rx MIMO Whitener to forward packet bearing signals to the BBMC. Instructions from the controller to the Rx MIMO whitener may include processing parameters (e.g. weights, DOA, etc.) to be applied to the packet bearing signal. These parameters may be based on the detected signal characteristics associated with the packet bearing signal as determined by the SCPDC. According to some embodiments in which the detection path and data paths are separated, the controller may, upon receiving a notification of the detection of a packet within a signal, send instructions to the Dynamic/Controllable Rx Beamforming unit to forward the packet bearing signal to the MIMO whitener unit and/or switch/multiplexer. Instructions from the controller to the Dynamic/Controllable Rx Beamforming Unit may include beamforming parameters (e.g. weights, DOA, etc.) to be applied to the specific packet bearing signal.

According to some embodiments, a SCPDC may comprise different types of packet detectors (as detailed below) and may utilize a different detector for different signals based on the signal's characteristics. Furthermore, a SCPDC may comprise multiple detectors and may perform packet detection separately on each signal (beam or pair of beams) isolated by the Rx Beamforming unit or a FBFU operating in parallel to the Dynamic/Controllable Rx beamforming unit. According to further embodiments, a SCPDC may substantially simultaneously perform packet detection and signal characterization of a received signal/beam. For a detailed description of simultaneous packet detection and signal characterization see the Applicants Issued U.S. Pat. No. 7,414,580, titled “Method and Corresponding Device for Joint Signal Detection And Direction of Arrival Estimation”, which is hereby incorporated herein in its entirety.

According to some embodiments, there may be multiple correlators featuring different predefined patterns, i.e. each correlator may identify a different type of signal (e.g. Barker, OFDM, Barker Multi Antenna, OFDM Multi Antenna, etc.), wherein the predefined patterns that correspond to multi antenna hypothesis may include: number of Tx antennas, their corresponding phase differences, their physical configurations and relative delays between Tx antennas. In embodiments featuring multiple different types of detectors/correlators, each type of correlator may be applied to each of the isolated signals. After the beamforming, when a required signal is received, one or more correlators may detect a correlation above a predefined threshold. The determination of the SCPDC may then be based on the characteristics of the one or more correlators that detected a packet.

According to some embodiments, the SCPDC may be further adapted to provide signal characterization information of a type selected from the group consisting of: (1) spatial distribution information relating to signals of the given received transmission; (2) DOA information relating to signals of the given received transmission; and (3) Channel Estimation (H) relating to signals of the given received transmission. The characterization information relating to a received transmission may also include DOA of a received transmission signal determined to have a relatively highest Signal to Noise Ratio (SNR), and the translation matrix may be generated with a steering vector derived from the determined DOAs.

According to some embodiments, packet detection may be performed by correlating the signals received from a predefined direction with a predefined correlation pattern. Exemplary predefined correlation patterns may be a training sequence or preamble. Optionally, when the signal features a repetitive pattern, this step may be done using Autocorrelation. According to some embodiments, packet detection may be performed by detecting the power of the input signal instead of correlating the signal. Power detection is less accurate than correlation, but also less expensive. According to some embodiments, packet detection may include spatial power detection of an input signal and/or signals. Signals featuring spatial power higher than a predefined threshold may be forwarded to correlators. According to some embodiments of the present invention, correlation may involve correlating only one signal received from only one antenna by using a predefined correlation pattern. The correlation result may then be power-detected. i.e. when the signal power exceeds a predefined threshold, it is likely that a required signal (packet) has been received by the antenna. This alternative embodiment may use only one correlator.

When a correlation result exceeds a predefined threshold, in a predefined direction, it may be likely that a packet is present within a signal being received from the appropriate predefined direction, at the detection time (up to some constant processing delay). Therefore, when the correlation result exceeds a predefined threshold, the signal may be identified as a potentially packet bearing signal.

Alternatively, when using power detection, when the power level of a signal exceeds a predefined threshold, it may be likely that a packet bearing signal is being received from the appropriate predefined direction. Therefore, when the power detection result exceeds a predefined threshold, the signal may be identified as a potentially packet bearing signal.

Alternatively, when correlating only one signal received from only one antenna using a predefined correlation pattern, it may be likely that a packet bearing signal is being received by the antenna. Therefore, signals from all directions are identified as potentially packet bearing signals. According to this alternative embodiment, the next step may be to search for the predefined direction featuring the maximum power level.

In another exemplary embodiment of the present invention, inputs may first be correlated, using at least one predefined pattern, and after that, the signals received from at least one predefined direction may be calculated. Exchange of the order between the correlation and the beamforming is possible because multiplication and correlation are linear operations and therefore the order of their performance may not alter the result.

According to some embodiments, the systems and methods of the present invention may be used to avoid interference by using repetitive detections of the same angle of arrival of an unwanted interfering signal and ignoring all signals received from the direction of that unwanted interfering signal.

BC100 may comprise a Dynamic/Controllable RX beamforming unit adapted to separate and isolate signals received at associated RX chains based on their DOA's. A SCPDC may perform packet detection separately on each signal (beam or pair of beams) isolated by an RX Beamforming unit and/or different detectors may be used for different signals/beams based on their characteristics.

The preamble portion may be transmitted from multiple antennas using cyclic shift diversity, implying multiple delayed versions of the preamble seen at the receiver. According to some embodiments, a detector may take this transmission type into account in order to correctly detect the transmitted preamble(s).

According to some embodiments of the present invention, SCPDC may comprise one or more diverse Tx packet detectors for performing packet detection upon received signals transmitted from multiple antennas. Diverse Tx packet detectors may utilize correlation detectors with a correlation pattern that considers the fact that the signal was transmitted from multiple antennas. For example, a transmission from multiple antennas may involve a predefined delay between Tx antennas. In this case the diverse Tx packet detector may correlate a single or multiple pattern each resulting from a delay hypothesis between the Tx antennas. E.g. Let s(t) be the known preamble transmitted at the beginning of each packet. The effective pattern for correlation may be one of the following s(t), s(t)+s(t−d1) s(t)+s(t−d1)+ . . . +s(t−d1) where each di is a delay hypothesis. Examples of a delay are 100 ns, 200 ns and 300 ns.

It should be noted that a single Tx transmission may be detected at both single and Multi-Antenna Detectors (the same holds for 2 Tx transmission). This means that control logic within or associated with the SCPDC may be used in order to choose the correct detector to use.

According to some embodiments, in order to improve performance, long correlators in respect to transmitted symbol time may be employed. Note that longer correlations may require additional hardware to accommodate multiple hypotheses respective to possible frequency offsets.

According to some embodiments, multi-antenna detectors may compensate for signal modifications performed during multi-antenna transmission of received signals. Above examples of compensation for delay in multi-stream transmissions is described (summation and squaring of correlator output). It should be understood that detectors may be provided to compensate for any other modification performed during multi-antenna transmission of received signals (e.g. phasing differences between Tx signals, delay differences between Tx signals or amplitude modification).

BC100 may comprise one or more Controllers, hereinafter collectively referred to as a controller. It should be understood that functions described herein as being performed by the controller may be performed by separate processing logic contained within BC100 (e.g. detection logic directly associated with packet detection circuitry). According to some embodiments, the controller may comprise: (1) control logic for coordinating the signal processing performed by BC100 upon signals exchanged between the BBMC and the RF chains; (2) signal processing logic for determining processing parameters to be used when processing a given signal; (3) control logic for controlling the RF chains and controlling and synchronizing between the BBMC and the RF chains. Control logic may also select to which receiver circuit or Modem to route a received signal based on characteristics of the received signal. BC100 may apply any one of a set of translation techniques/procedures (including beam-forming) to a received signal being routed to either of the receivers, optionally based on which receiver is being routed the signal.

According to some embodiments, BC100 may coordinate Rx and Tx operation of the RF chains and BBMC. BC100 may switch between Rx active, Rx passive and Tx active modes. Determination of mode may be based on status indications and transmission indications received from the BBMC and/or on packet detection. For example, BC100 may switch components to Rx active when a data packet is detected within a received signal. BC100 may switch components to Tx active when receiving a transmission indication from the BBMC. BC100 may switch to Rx passive when receiving a modem status active from the BBMC.

According to some embodiments, within Tx Active mode the controller may decide if an intended transmission is designated for multicast, singlecast or it is a response to an incoming reception (e.g. Ack). For each case the controller may set the transmission parameters accordingly and sustain this state until the end of transmission. According to some embodiments, within Rx Passive mode the controller may continuously search for a new packet to process. The detection may be active for both single stream and multi stream signals. Furthermore, the BBMMC chip may be insulated from received signals, i.e. signals are not forwarded to the BBMC. According to further embodiments, within Rx Active mode the Rx parameters may be optimized to allow optimal demodulation of the single or multi stream signal. Once determined, the Rx processing parameters for a given signal may be frozen until the end of reception of the given signal.

According to some embodiments, beamforming in multiple/all defined directions may be performed in parallel. Beamforming as described herein may be performed by multiplying signals by predefined weights, such as: (1) by an Inverse Discrete Fourier Transform (IFFT); (2) by matrix vector multiplication; and/or (3) by any other beamforming technique known today or to be devised in the future.

### Whitening of Signals

According to some embodiments, BC100 may comprise a Rx MIMO whitener unit for performing MIMO whitening of Rx signals originating from the RF chains. According to embodiments of BC100 which include beam forming, uncorrelated background noise may become correlated and thus impede demodulation of the received signals. A Rx MIMO whitening unit may decorrelate noise within one or more of the RX signals associated with a given beam. According to some embodiments, a Rx MIMO whitener unit may receive from an associated controller parameters relating to whitening of specific Rx signals, wherein the associated controller may determine these parameters at least partially based on signal characteristics and/or parameters derived from signal characteristics of the specific Rx beamformed signals. According to some embodiments, these signal characteristics or derived parameters may also be derived from previous communication with the given client. According to further embodiments, a packet detector may notify the controller of the received signal and its characteristics. According to some embodiments, whitening may comprise decorrelating noise across multiple inputs. According to further embodiments, whitening may comprise decorrelating noise across multiple inputs while relaying one input unchanged, i.e. as is.

According to some embodiments of the present invention, BC100 may perform a dual stage processing of signals received at N antennas prior to providing the processed signals as inputs to K inputs of a multi-input BBMC.

According to some embodiments, first stage processing may include a beam forming and/or best beam selection (in cases where a set of beams if predefined) as described further herein. Beam forming and/or beam selection may be based on a spatial correlation estimation or determination performed by a SCPDC on the received signal. Optionally an SINR estimation per beam candidate may be factored as part of beam forming and/or beam selection, such that beam selection may favor beams with a higher ratio between a received SNR and inter-symbol interference/interference.

According to further embodiments, measurement or estimation of interference may be performed either during idle periods or during reception.

According to further embodiments the selection may be constrained:
(1) Such that an overlap between selected beams is mitigated (e.g. minimized)—for example if the direction of a first beam is 0 degrees, no other selected beams will be have an angular direction of less than +/−10 degrees from 0.
(2) Selection may further be constrained to limited number of output beams, for example three.
   An output of the first processing stage may be a beamformed matrix.

According to further embodiments, the second stage may include spatial whitening for further processing the received signals before forwarding them to the BBMC. For example, if W is a matrix that consists of the respective selected beamforming coefficient per beam in each line as the result of stage 1. And, furthermore, if n is the appropriate noise instance vector which can be assumed to an i.i.d complex Gaussian random variable with zero mean and variance c. By definition, the noise covariance C may then be defined as

C=E{(AW*n)(AW*n)*},

The whitening matrix A, used as part of matrix multiplication of the signals, may be designed to decorrelate the noise at the entrance to the BBMC according to the following requirement as: “find A such that:

C=E{(AW*n)(AW*n)*}=c×I.”

When deployed in an outdoor urban environment, an OFDM based wireless communication system may experience delay-spread which significantly exceeds the cyclic prefix (CP) duration of the 802.11n. Without proper mitigation, this may lead to ISI and significant performance degradation. An efficient means to reduce the experienced ISI may be the employment of beamforming (BF). The beamforming unit may be crafted to amplify strong reflection/s while suppressing delayed reflections, thus reducing the experienced delay spread.

According to some embodiments, the BC100 may estimate a time of arrival difference between different beams. Furthermore, given the estimated delay between beams the BC100 may compensate for the time of arrival differences prior to communicating the beamformed signals to the modem.

Considering, for example an IEEE802.11n receiver with 4 receive (Rx) antennas, and a near optimal OFDM-MIMO decoder for the 3(Rx)×2(Tx) case. The goal may be to construct (up to) 3 beams, using a detector, each featuring sufficiently low delay spread. The beamformed signals may then be provided to the MIMO Whitener receiver.

Beams may be constructed that are targeting the strongest reflections, which are sufficiently distant in the DOA domain.

According to some embodiments, a Rx MIMO whitener unit may receive from an associated controller parameters relating to whitening of specific Rx signals, wherein the associated controller may determine these parameters at least partially based on signal characteristics and/or parameters derived from signal characteristics of the specific Rx signals. These signal characteristics or derived parameters may also be derived from previous communication with the given client. According to further embodiments, a packet detector may notify the controller of the received signal and its characteristics. According to some embodiments, whitening may comprise decorrelating noise across multiple inputs. According to further embodiments, whitening may comprise decorrelating noise across multiple inputs while transferring one antenna signal unchanged. That means that a single beam from the multi beam selection is transferred as is to the modem/detector.

A BBMC may be further adapted to generate a transmission including one or more streams, and the BC100 may further include a Tx MIMO expansion unit adapted to translate the transmission into N antenna transmit signals based on either signal characterization information or a translation matrix stored in said digital memory. The Tx MIMO expansion unit may be adapted to apply Maximum Ratio Combining (MRC) to the transmission signals. According to some embodiments, a Tx MIMO expansion unit may receive from an associated controller parameters relating to spatial expansion of specific BBMC signals, wherein the associated controller may determine these parameters at least partially based on signal characteristics and/or parameters derived from signal characteristics associated with the given wireless client the Tx signals are intended for. These signal characteristics or derived parameters may be derived from previous communication with the given client. According to further embodiments, a BBMC may notify the controller of the intended transmission—BC100 may comprise a dedicated interface for receiving the notification from the BBMC.

BC100 may comprise a Dynamic/Controllable Tx beamforming unit for forming Tx signals originating from the BBMC into beams. According to some embodiments, The BC100 controller may instruct the Dynamic/Controllable Tx beamforming unit to form Tx signals into beams based on signal characteristics of signals received from/transmitted to the wireless client for which the Tx signal is intended. For example, the BC100 controller may instruct the Dynamic/Controllable Tx beamforming unit to form the transmission beam based on the DOAs of transmissions received from the relevant wireless client. According to further embodiments, a BBMC may notify the controller of the intended transmission.

According to further embodiments, SCPDC may provide a controller with received transmission signal characterization information relating to a received transmission. The controller may be adapted to forward a received transmission for demodulation to said single-stream modem when the transmission signal characterization information relating to the received transmission indicates it is a single stream transmission or single carrier transmission.

According to some embodiments, BC100 may further use the above described components and processes for obtaining cancellation of dynamic disturbance. In order to perform cancellation of dynamic disturbance, there may be a need to know the disturbances and the transmitted signals. Moreover, there may be a need to have starting and ending conditions. In an exemplary embodiment of the present invention, the system of the present invention may provide the direction of arrival of the signal causing the disturbance, as a starting condition for a dynamic disturbance canceling algorithm. This starting condition may enable the initialization of, for example, LMS equations, and NULL reduction algorithms such as generalized sidelobe cancellers.

In another exemplary embodiment of the present invention, the present invention may determine a desired signal, which may be useful for initializing blind nulling algorithms. When a disturbing signal from a certain direction is identified, beamforming may be used to place a NULL in the direction causing the disturbance.

According to some embodiments, the present invention may be useful for finding known types of echoes featuring an antenna array, in ultrasound. Moreover, the present invention may be useful for sonar searching for a specific signal, wherein the sonar is built from a microphone array. Furthermore, the present invention may be useful for acoustically pinpointing a DOA of a sound, using a microphone array to identify the direction from which a sound wave, having a set of required characteristics, arrives.

According to further embodiments, the above described methods and components may be useful when searching for a known signal in a wide spectral interval or when searching for a specific user by listening to the media. For example, military and police forces search for users who are transmitting from a certain type of communications equipment having known characteristics. According to the some embodiments, illegal signals may be filtered out before they are forwarded to the modem.

### Calibration

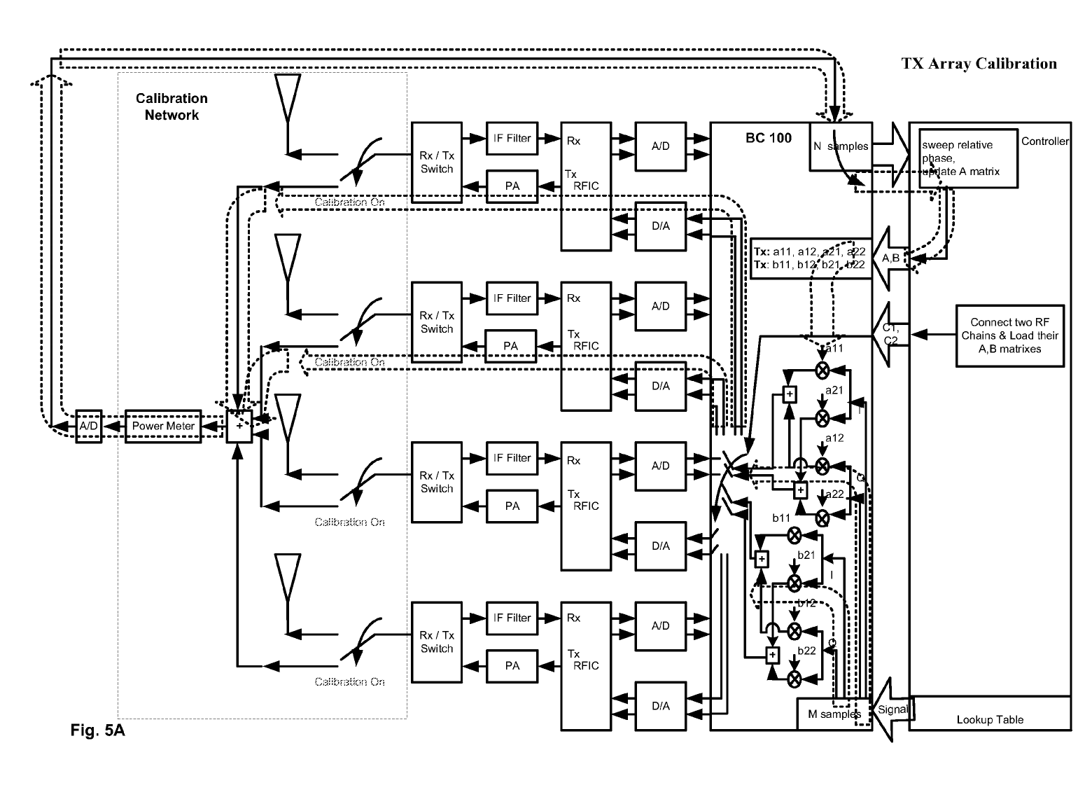

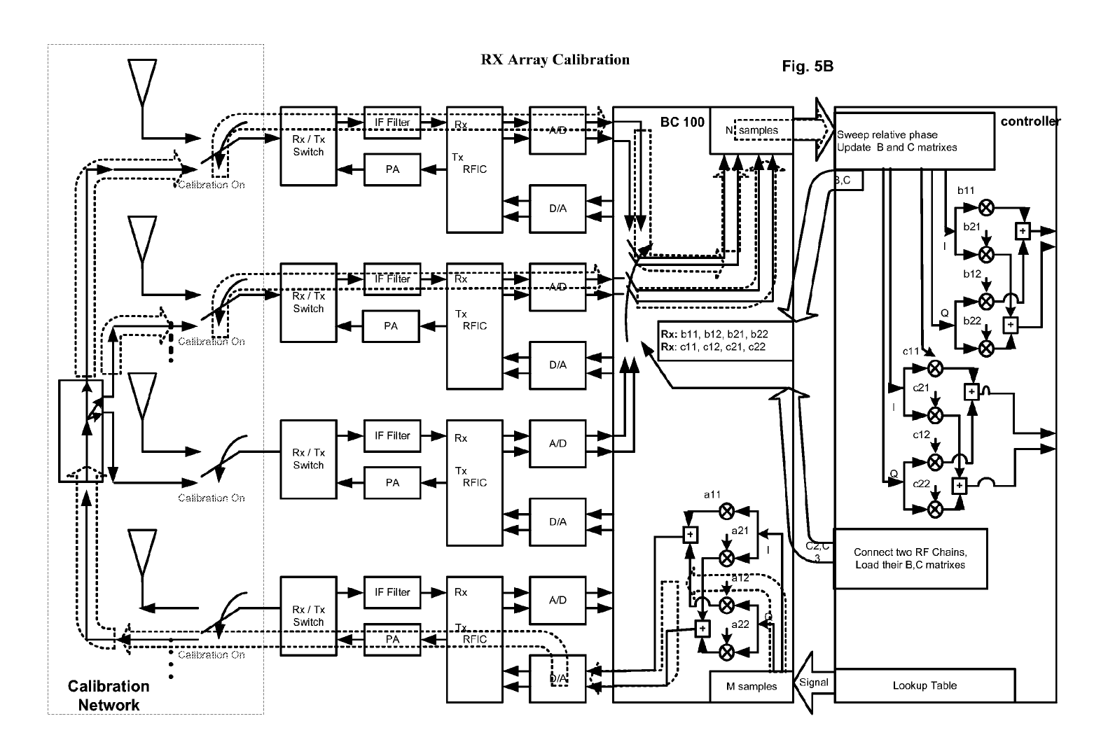

According to some embodiments, BC100 may be further adapted to calibrate RF chains. Calibration of RF chain parameters may be performed upon initial instancement, upon activation, periodically and/or upon detection of a miscalibration or upon any event which may affect calibration of the RF chains. Below are described exemplary algorithms and implementation considerations of the calibrations that may occur. According to some embodiments, as those shown in FIGS. 5A and 5B, there may be provided a calibration network including: (1) one or more switches situated on a signal path between given RF chains output/input ports and each chains' corresponding antenna element; and (2) one or more power meters into which an output of one or more RF chains may be bridged. Additionally, according to some embodiments, port to port transfer characteristics (e.g. attenuation and phase shifting) of the calibration network may be known for one or a range of signal frequencies.

According to some embodiments, BC100 may include a calibration network (shown in FIGS. 5A & 5B). A calibration network may be adapted to switch between Rx and TX signal flow and may further provide for the connection of any antenna to any other antenna, and/or the connection of one or more antennas to a power detector (and hence to effectively combine the transmission of two or more antennas and to measure their effective power).

There may be two primary sources of imbalance errors:
1) RFIC phase, gain, DC.
2) RF chain relative gain and phase—which are required for smart antenna/beamforming operation.
   For each Rx or Tx path there may be different errors. E.g. different errors relating to phase offset, DC and IQ offset.

### TX Array Calibration

During Tx Array calibration there may be a need to compensate for possible phase differences between Tx antennas. The same signal (a sine wave, a white Gaussian noise or a direct sequence spread spectrum or an OFDM signal for example) may be transmitted to all the antennas.

The power of the combined signal of each two antennas may be measured one pair at a time. Using several phase difference hypotheses, the minimum power may be searched for. At this minimum, it may be known that the two antennas have a phase difference of 180 degrees, hence to find the coherent phase 180 degrees may be added to the found phase. This process may be done for each antenna in relation to a first antenna, or to any antenna selected as a reference. For example, in the case of four antennas: 1 with 2, 1 with 3 and 1 with 4.

After the Tx/Rx general calibrations (DC offset, IQ imbalance, antenna output power and Rx gain) are finished the antenna array as a whole may be calibrated.

FIG. 5A demonstrates an exemplary Tx Array calibration process (the direction of the data flow is shown by dotted arrows).

Starting at the lower right corner in the controller: The controller may generate M samples of a first testing pattern for the I path and a second testing pattern for the Q path (the testing patterns may be any testing signal forwarded to the RF chains, e.g. a sine or cosine tone, a direct sequence spread spectrum signal, samples generated by a Gaussian distribution, etc.). These base-band (BB) samples (at frequency Ftone) may be written to a controller buffer. In addition, the controller may decide on two comparable RF chains. The controller may pass the samples (I/Q sample at a time) through the D/A into the RFIC unit of the two chosen chains. At the end of the chains the signals may be combined and passed through a power meter device. The output may be read by the controller and accumulated. Then a differential phase between the two chosen RF chains may be swept over by updating the chain's A matrix. (note: the controller may remember/store the chain's A matrixes to update them with the new phase shift!). The above procedure may be repeated with the same two RF chains with the modified A matrix. After finishing all hypothesis phases in the range, the controller may choose the phase difference that yielded the minimum power meter result. The calibration of these two RF chains may have ended. Now a second RF chain may be calibrated. For example, in a case of four antennas, the RF chains may be calibrated in the following order: First a RF chain may be chosen as a reference chain. (e.g. ch1). Subsequently: ch1 may be calibrated with ch2, ch1 with ch3 and ch1 with ch4. At the end, all three chains may have a coherent phase to ch1.

### Rx Array Calibration

During Rx Array calibration, it may be necessary to compensate for possible phase differences between the antennas in the reception path. A signal may be transmitted through one antenna to all the other three antennas. Taking two antennas at a time, the cross-correlation of the two antennas may be measured. Taking the argument of the cross-correlation of the two signals the relative phase may be found. This process may be performed for each antenna in relation to a first antenna. For example, in the case of four antennas: 1 with 2, 1 with 3 (while transmitting through 4), 1 with 4 (while transmitting through 3).

In Rx Array calibration, a predefined pattern may be transmitted through a selected chain, and received via the other three chains. FIG. 5B demonstrates an exemplary Rx Array calibration process (the direction of the data flow is shown by dotted arrows).

Starting at the lower right corner in the controller: The controller may generate M samples of a first testing pattern for the I path and second testing pattern for the Q path (the testing patterns may be any testing signal forwarded to the RF chains, e.g. a sine or cosine tone, a direct sequence spread spectrum signal, samples generated by a Gaussian distribution, etc.). These base-band (BB) samples (at frequency Ftone) may be written to the controller buffer. In addition, the controller may decide on two comparable RF chains (denoted ‘ch2’, ‘ch3’). The controller may correct the Tx IQ imbalance by multiplying it with its previously computed correction matrix. Then it may pass the samples (I/Q sample at a time) through the D/A into the RFIC unit (via chain ‘ch1’). At the RF stage the signal may be looped back to the other chains (‘ch2’, ‘ch3’ and ‘ch4’). The controller may select the data received from the two pre-selected chains (‘ch2’ and ‘ch3’) and accumulate it for the controller. When a stabilizing time has passed, the controller may calculate the phase difference and update a new B correction matrix (note: the controller may remember/store the chain's B matrixes to update them with the new phase shift!). Subsequently a second RF chain may be calibrated. Therefore, for example, in the case of four antennas the RF chains may be calibrated in the following order: First a RF chain may be chosen as a transmitter chain (e.g. ch1). Then a second RF chain may be chosen as a reference chain. (e.g. ch2). Then, ch2 may be calibrated with ch3 and ch2 with ch4. Now the transmitter chain may be switched by another (e.g. ch3). Now ch1 may be calibrated to ch2. At the end, all three chains may have a coherent phase to ch2.

### ALTERNATE EMBODIMENTS

It should also be understood that under certain embodiments BC100 may include separate signal processing circuits for both a single-stream circuit and for a multi-stream modem circuit. For a single-stream modem, BC100 may include a beam-forming block/circuit and/or an MRC circuit. Whereas for a multi-stream modem, BC100 may include a spatial expansion block/circuit and/or an MRC circuit. Conversely, any functional blocks and their respective functionality described herein may be integrated into a single multifunction circuit as known today or to be devised in the future.

It should be understood that some functions described herein as being performed by one module/unit may be performed by separate modules/units and some functions described herein as being performed by separate modules/units may be performed by one module/unit. For example, there may be provided a transceiver arrangement including a first transmitter circuit adapted to transmit a data bearing signal using a modulation technique including beam-forming. A second transmitter circuit may be adapted to transmit a data bearing signal using a modulation technique not-including beam-forming, and a selective beam-forming unit may be adapted to selectively operate on a signal generated by the second circuit. The transceiver arrangement may include an adaptive antenna adapted to transmit signals, also including signals processed/conditioned using an adaptive antenna signal processing/conditioning technique. The transceiver arrangement may apply processing/conditioning techniques such as MIMO (Multiple Input Multiple Output) processing/conditioning.

The transceiver arrangement may be implemented with the first transmitter circuit, the second transmitter circuit, the selective beam-forming unit and the adaptive antenna being integrated on a single chip.

The transceiver arrangement may be implemented with the first transmitter circuit, the second transmitter circuit and the selective beam-forming unit being integrated on a first chip, and the adaptive antenna being implemented on a second chip.

The transceiver arrangement may be implement with the first transmitter circuit being integrated on a first chip, the second transmitter circuit being integrated on a second chip, and the selective beam-forming unit and the adaptive antenna being integrated on a third chip.

In another example, a transceiver arrangement may include a first receiver circuit adapted to receive a data bearing signal transmitted using a modulation technique including beam-forming A second receiver circuit may be adapted to receive a data bearing signal transmitted using a modulation technique not-including beam-forming, and a selective beam-forming unit may be adapted to detect whether a received signal was transmitted using a modulation technique including beam-forming and selectively operate on the received signal according to the detection.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk-read only memory (CD-ROM), compact disk-read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments, or vice versa.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

We claim:

1. A wireless communication system comprising:
a radio block comprising two or more radio frequency chains for receiving and transmitting wireless signals including wireless data packets;
a modem block comprising one or more baseband modem circuits; and
bridging circuitry situated on a signal path between said radio block and said modem block adapted to perform digital preprocessing of signals received by said radio frequency chains and to forward the preprocessed signals to at least one of said one or more modem circuits, said bridging circuitry comprising:
wireless packet detection and characterization circuitry adapted to detect arrival of a given wireless packet and estimate one or more multipath directions from which the given wireless packet is arriving;
direction selection logic adapted to select two or more wireless packet arrival directions for reception; and
a dynamic Rx beamforming unit adapted to either generate or to steer an Rx beam in each of the selected wireless packet arrival directions.

2. The system according to claim 1, wherein said direction selection logic is adapted to select two or more directions for reception based on detected packet parameters determined by said packet detection and characterization circuitry.

3. The system according to claim 2, wherein packet parameters used to select two or more directions for reception are selected from the group consisting of: (1) post-beamforming energy within cyclic prefix of detected packet preamble; (2) A ratio of post-beamforming energy within cyclic prefix of detected packet preamble over the energy outside of the cyclic prefix of detected packet preamble; and (3) a ratio of post beamforming energy within cyclic prefix of detected packet preamble over the energy outside of the cyclic prefix of detected packet preamble combined with the estimated noise energy.

4. The system according to claim 3, wherein a maximum allowable beam overlap threshold is factored as part of selecting two or more directions for reception and dynamic beamforming.

5. The system according to claim 1, wherein the wireless packet detection and characterization circuitry comprises a set of match filters, and wherein substantially each match filter is configured for a specific direction of arrival.

6. The system according to claim 5, wherein each match filter is configured for a specific direction of arrival and a specific client transmission antenna configuration.

7. The system according to claim 1, wherein the wireless packet detection and characterization circuitry comprises time of arrival (TOA) measurement or estimation functionality for determining a difference in time of arrival for the given packet from different directions.

8. The system according to claim 7, wherein output at beam ports of the beamforming unit are dynamically adjusted or delayed for the given packet based on the TOA estimates for each of the selected packet reception directions.

9. The system according to claim 1, wherein said bridging circuitry comprises a Whitener unit for whitening beamformed signals.

10. The system according to claim 9, wherein whitening comprises decorrelating noise across multiple inputs while relaying one antenna signal without decorrelation, such that said whitener unit outputs two or more signals comprising decorrelated noise and one signal unchanged from its form as received by an RF Chain.

11. The system according to claim 9, wherein said whitener unit is adapted to perform whitening of given received signals based on signal parameters determined by said packet detection and characterization circuitry in relation to the given received signals.

12. The system according to claim 1, further comprising a calibration network.

13. The system according to claim 12, wherein said bridging circuitry is further adapted to: (1) use said calibration network to determine phase differences between said radio frequency chains; and (2) compensate for the determined phase differences.

14. A wireless communication system comprising:
a radio block comprising two or more radio frequency chains for receiving and transmitting wireless signals;
a modem block comprising one or more baseband modem circuits; and
bridging circuitry situated on a signal path between said radio block and said modem block and adapted to perform digital preprocessing of signals received from said one or more modem circuits and to forward the preprocessed signals to at least one of said radio frequency chains for transmission, said bridging circuitry comprising:
wireless packet detection and characterization circuitry adapted to detect arrival of a given packet from a given client device and to estimate one or more multipath directions from which the given wireless packet arrived;
a dynamic Tx beamforming unit adapted to perform beamforming upon signals received from said modem circuits; and
a controller adapted to cause said Tx beamforming unit to perform beamforming, of two or more beams in two or more selected directions, for transmitting a signal generated by said modem circuits and intended for the given client device, wherein direction selection for Tx beamforming is at least partially based on parameters determined by said packet detection and characterization circuitry for the given wireless packet received from the given client device.

15. The system according to claim 14, wherein packet parameters used to select two or more directions for Tx beamforming are selected from the group consisting of: (1) post-beamforming energy within cyclic prefix of detected packet preamble; (2) A ratio of post-beamforming energy within cyclic prefix of detected packet preamble over the energy outside of the cyclic prefix of detected packet preamble; and (3) a ratio of post beamforming energy within cyclic prefix of detected packet preamble over the energy outside of the cyclic prefix of detected packet preamble combined with the estimated noise energy.

16. The system according to claim 15, wherein a maximum allowable beam overlap threshold is factored as part of selecting two or more directions for Tx beamforming.

17. The system according to claim 15, wherein Tx beamforming includes selection of an energy level per selected Tx direction.

18. The system according to claim 14, wherein Tx beamforming includes selection of a delay to apply to each beam port of said Tx beamforming unit.

19. The system according to claim 14, wherein said bridging circuitry is further adapted to perform spatial expansion upon the signal generated by said modem circuits based on the parameters determined by said packet detection and characterization circuitry in relation to the one or more signals received from the wireless client.

20. A system for providing wireless data communication comprising:
a radio block comprising two or more radio frequency chains for receiving and transmitting wireless signals;
a modem block comprising one or more baseband modem circuits; and
a calibration network adapted to facilitate determination of phase differences between said radio frequency chains; and
bridging circuitry situated on a signal path between said radio block, said calibration network and said modem block adapted to perform dynamic Rx beamforming and dynamic Tx beamforming of signals received or transmitted by said radio block while compensating for the phase differences between said radio frequency chains.

21. The system according to claim 20, wherein said bridging circuitry is further adapted to receive signals for transmission from said baseband modem circuits, process the signals for transmission and transfer the processed signals for transmission to said RF chains.

22. Bridging circuitry comprising:
one or more inputs for receiving signals from one or more Radio Frequency (RF) Chains;
one or more outputs for forwarding signals to one or more baseband modem circuits; and
first signal processing circuitry adapted to be situated on a signal path between the RF Chains and the modem circuits and to perform digital preprocessing of signals received from the RF chains and to forward the preprocessed signals to at least one of the one or more modem circuits.

23. The bridging circuitry according to claim 22, wherein said first signal processing circuitry comprises:
packet detection and characterization circuitry; and
dynamic Rx beamforming circuitry for forming at least two beams for each packet.

24. The bridging circuitry according to claim 23, wherein said dynamic Rx beamforming circuitry is adapted to perform beamforming of the received signals based on signal parameters determined by said packet detection and characterization circuitry.

25. The bridging circuitry according to claim 22, wherein said first signal processing circuitry comprises a Whitener unit for whitening at least one of the received signals.

26. The bridging circuitry according to claim 25, wherein whitening comprises decorrelating noise across multiple inputs while passing one antenna signal without decorrelation.

27. The bridging circuitry according to claim 25, wherein said first signal processing circuitry comprises packet detection and characterization circuitry and said whitener unit is adapted to perform whitening of received signals based on signal parameters determined by said packet detection and characterization circuitry.

28. The bridging circuitry according to claim 22, wherein said first signal processing circuitry comprises calibration circuitry adapted to perform calibration of the RF chains.
